(19) United States
(12) Patent Application Publication
(10) Pub. No.: US 2026/0088683 A1
(43) Pub. Date: Mar. 26, 2026

(54) REDUCER WITH TORQUE SENSING STRUCTURE AND FLEXIBLE COMPONENT THEREOF

(71) Applicant: DELTA ELECTRONICS, INC., Taoyuan City (TW)

(72) Inventors: Chi-Wen Chung, Taoyuan City (TW); Hsien-Lung Tsai, Taoyuan City (TW); Wei-Ying Chu, Taoyuan City (TW); Wan-You Cai, Taoyuan City (TW)

(21) Appl. No.: 19/274,367

(22) Filed: Jul. 18, 2025

Related U.S. Application Data
(60) Provisional application No. 63/698,296, filed on Sep. 24, 2024.

(30) Foreign Application Priority Data
Apr. 30, 2025 (CN) 202510564090.5

(51) Int. Cl. H02K 11/24; H02K 11/21

(52) U.S. Cl. CPC H02K 11/24; H02K 11/21

(57) ABSTRACT

A reducer with a torque sensing structure and a flexible component thereof are disclosed. The flexible component is axially arranged on an output plate of a rotating mechanical device such as a reducer, and includes a flexible body and at least two flexible arms. The flexible body is axially arranged on the output plate. The at least two flexible arms are extended outwardly from the flexible body perpendicular to the axial direction. When the reducer outputs torque through the output plate, the at least two flexible arms are deformed by force, causing the flexible body to form a shifted position difference. By comparing the shifted position difference and a rotational position of the output plate, an output torque value can be calculated to realize the application of the torque sensor.

### CROSS-REFERENCE TO RELATED APPLICATION

This application claims the benefit of U.S. Provisional Application No. 63/698,296 filed on September 24, 2024, and entitled “CLOSE LOOP GEARMOTOR AND REDUCER ASSEMBLY WITH TORQUE SENSING STRUCTURE”. This application claims priority to China Patent Application No. 202510564090.5, filed on April 30, 2025. The entireties of the above-mentioned patent applications are incorporated herein by reference for all purposes.

### FIELD OF THE INVENTION

The present disclosure relates to a speed reducer, and more particularly to a reducer with a torque sensing structure and a flexible component thereof. Torque sensing is achieved through the configuration of the flexible components and encoders for closed-loop feedback control, so as to improve the control accuracy of the system.

### BACKGROUND OF THE INVENTION

In high-precision/high-torque equipment, the direct drive motor (DD motor) and the servo motor with the reducer are two common design schemes for the transmission system. Since the loss of the reducer and the backlash rigidity of the reducer are eliminated, the direct drive system has better performance in terms of efficiency/precision. However, when high torque needs to be provided, the motor will be very large and the cost will be increased accordingly. As for the configuration scheme equipped with the reducer, it can usually save a lot of space compared to the direct drive system. In other words, in the same design space, the servo motor with the reducer provides greater torque. However, since the common reducers and servo motors are mostly utilized in open-loop applications. The motor has an encoder at the input end to control the position merely. The position after action of the reducer is determined by the accuracy of the reducer and also easily affected by the temperature. Therefore, the servo motor with the reducer is usually slightly inferior to the direct drive system in terms of accuracy.

In order to improve the accuracy control, another encoder is added at the output end of the reducer for feedback control. However, in the conventional configuration of the servo motor and the reducer, the output end of the reducer and the motor are respectively located at the two opposite ends of the reducer. When an encoder needs to be added to the output end of the reducer for closed-loop feedback control, the design mechanism will become complicated and the cost will be increased a lot. Even the circuitry/routing is a difficult issue. Namely, in the combination of the reducer and the motor, if the encoder must be installed at the output end, the design mechanism will become complicated and the cost will be increased a lot. Furthermore, the circuitry/routing is another difficult issue.

Therefore, there is a need of providing a reducer with a torque sensing structure and a flexible component thereof. Torque sensing is achieved through the configuration of the flexible components and encoders for closed-loop feedback control, so as to improve the control accuracy of the system, and overcome the above drawbacks.

### SUMMARY OF THE INVENTION

An object of the present disclosure is to provide a reducer with a torque sensing structure and a flexible component thereof. Torque sensing is achieved through the configuration of the flexible components and encoders for closed-loop feedback control, so as to improve the control accuracy of the system.

Another object of the present disclosure is to provide a reducer with a torque sensing structure and a flexible component thereof. The reducer of the present disclosure is miniaturized by optimizing the component structure, it facilitates to arrange encoders between the reducer and the motor for closed-loop feedback control, and the output end of the reducer is further combined with a flexible component to achieve torque sensing. The first encoder module is used to measure a rotational position of the output end of the reducer, and the second encoder module is used to measure the position of the flexible component. There is a shifted position difference between the two measured positions, and the shifted position difference is the result of the deformation of the flexible component after being subjected to a torsional force. If the stiffness of the flexible component is obtained, the output torque value is calculated, so that the application of the torque sensor is realized. Furthermore, the reducer of the present disclosure includes a front output plate and a rear output plate served as the output ends. The rear output plate faces the motor. The flexible component is disposed on the front output plate, and axially penetrates to the rear output plate to connect with the second encoder module. The first encoder module can be constructed integrally with a third encoder module between the rear output plate and the motor, and share one encoder reader to reduce the costs and improve the convenience and the space utilization. On the other hand, the flexible component arranged at the output end includes a flexible body and at least two flexible arms. The at least two flexible arms are perpendicular to the axial direction of the output end, and bent or extended outward from the flexible body. In that, when the reducer outputs the torque, the flexible body is deformed by the torque to form a shifted position difference, so as to further realize the application of the torque sensor. Since the inner end of the flexible arm is extended outward or bent from the flexible body and has a thin-walled structure perpendicular to the output plate, it allows to provide sufficient deformation. The outer end of the flexible arm is fastened to a lateral wall of the protrusion at the output end along the circumferential direction or radial direction (vertical to the axial direction) by at least one screw, or fixed through a fixing ring to provide better torque resistance. Certainly, the flexible components should absorb the torque as much as possible, while the radial force and the axial force are supported through other structures, such as cross rollers or bearing sets. In the reducer of the present disclosure, the front output plate and rear output plate transmit the torque through the eccentric motion of multiple straight shafts. The straight shaft includes an extended section running through the front output plate and combined with an outer sleeve bearing and the front output plate in an interference manner. Notably, the flexible component of the present disclosure further includes a plurality of grooves disposed on an outer periphery of the flexible body, and corresponding to the outer sleeve bearings structured on the plurality of straight shafts. The outer rings of the outer sleeve bearings are located in the corresponding grooves. In this way, the outer ring of the outer sleeve bearing is allowed to provide a radial supporting force for the flexible body. Moreover, while the flat surface of the outer ring of the outer sleeve bearing is attached to the flat surface of the corresponding groove, it is allowed to provide an axial supporting force for the flexible body. In addition, the groove is designed to have a larger arc curvature corresponding to the outer diameter of the outer ring bearing, so as to form an interference point between the flexible body and the outer sleeve bearing at one end of the groove. The interference point is served as a limit position stop point for allowable deformation. In other words, the arc curvature of the groove can be designed according to the limit angle of the flexible body after deformation to optimize the contact position as the limit position stop point. Certainly, in the present disclosure, the structure of the groove is not limited to one single arc curvature. The grooves with multi-segment design can form the interference points with the outer sleeve bearing at the maximum deformation angle. Therefore, the flexible body of the present disclosure can be axially disposed on the output plate of the rotating mechanical device to achieve torque sensing.

In accordance with an aspect of the present disclosure, a reducer with a torque sensing structure is provided and includes an input shaft, a reducer main body, an output end, a first encoder module, a flexible component and a second encoder module. The input shaft is connected to a motor along an axial direction, and driven by the motor. The reducer main body is arranged along the axial direction, and sleeved on the input shaft. The output end is arranged along the axial direction and connected to the reducer main body, wherein the input shaft is driven by the motor to rotate the reducer main body to act on the output end, and the output end is rotated. The first encoder module is disposed between the output end and the motor and configured to measure a rotational position of the output end. The flexible component includes a flexible body and at least two flexible arms, wherein the flexible body is axially arranged on the output end, the at least two flexible arms are perpendicular to the axial direction, and extended outwardly from the flexible body, and the at least two flexible arms are allowed to deform under force and make the flexible body to form a shifted position difference. The second encoder module is spatially corresponding to the flexible component, wherein the shifted position difference measured by the second encoder module allows an output torque value to be calculated by comparing the rotational position of the output end measured by the first encoder module.

In an embodiment, the output end includes a first output plate and a second output plate, which are arranged at two opposite outer sides of the reducer main body along the axial direction, and connected to the reducer main body through a plurality of straight shafts, wherein the first output plate faces the motor, a power input source of the motor is inputted through the input shaft, and an eccentric movement of the reducer main body and the plurality of straight shafts is driven by the input shaft, so that the plurality of straight shafts drive the first output plate and the second output plate to rotate, and a power output is provided by the first output plate and the second output plate, respectively.

In an embodiment, the first encoder module is disposed between the first output plate and the motor, and configured to measure the rotational position of the first output plate for feedback control.

In an embodiment, the first encoder module includes an encoder and an encoder read head, the encoder is connected to the first output plate, and the first output plate drives the encoder to output and rotate synchronously, wherein the encoder read head is spatially corresponding to the encoder, and configured to measure the rotational position of the first output plate for feedback control.

In an embodiment, the reducer further includes a third encoder module disposed between the first output plate and the motor, wherein the input shaft is a hollow input shaft, and the third encoder module includes a motor encoder and an encoder read head configured to measure a rotational position of the input shaft or a driving-shaft position for feedback control, wherein the encoder read head of the first encoder module and the encoder read head of the third encoder module are arranged on two opposite sides of a circuit board, respectively.

In an embodiment, the input shaft is a hollow input shaft, the flexible component further includes an extension end, the extension end passes through the input shaft along the axial direction from the flexible body to a rear end of the motor, wherein the second encoder module is arranged at the rear end, and configured to measure rotation of the extension end to realize torque sensing.

In an embodiment, each of the plurality of straight shafts includes an extension section penetrating through the second output plate and connected to the second output plate in an interference manner, and the extension section interferes with an outer sleeve bearing.

In an embodiment, the flexible body further includes a plurality of grooves spatially corresponding to the outer sleeve bearings outside the plurality of straight axes, and the outer sleeve bearing is in contact with a corresponding one of the plurality of grooves.

In an embodiment, the plurality of grooves have an arc curvature corresponding to the outer sleeve bearing, and the arc curvature is greater than an outer diameter of the outer sleeve bearing, so as to form an interference point between the flexible body and the outer sleeve bearing at one end of the corresponding one of the grooves.

In an embodiment, the at least two flexible arms are extended radially from inside to outside, inner end of the at least two flexible arms are connected to the flexible body, and outer ends of the at least two flexible arms are respectively fixed to a lateral wall of a protrusion of the output end along a circumferential direction by at least one screw.

In an embodiment, the at least two flexible arms are extended and bent from inside to outside, inner end of the at least two flexible arms are connected to the flexible body, and outer ends of the at least two flexible arms are respectively fixed to a lateral wall of a protrusion of the output end along a radial direction by at least one screw.

In an embodiment, the flexible component further includes a fixing ring disposed on an outer periphery of the flexible body, the at least two flexible arms are extended and bent from inside to outside, inner end of the at least two flexible arms are connected to the flexible body, outer ends of the at least two flexible arms are respectively connected to the fixing ring, and the fixing ring is fixed to the output end along the axial direction by a plurality of screws.

In accordance with another aspect of the present disclosure, a flexible component is provided and configured to be disposed on an output end of a rotating mechanical device along an axial direction. The flexible component includes a flexible body and at least two flexible arms. The flexible body is disposed on the output end along the axial direction. The at least two flexible arms are perpendicular to the axial direction, and extended outwardly from the flexible body, wherein when the rotating mechanical device outputs torque through the output end, the at least two flexible arms are allowed to deform under force and make the flexible body to form a shifted position difference, and the shifted position difference allows an output torque value to be calculated by comparing a rotational position of the output end.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a perspective view illustrating a reducer assembly according to a first embodiment of the present disclosure from a front perspective;

FIG. 2 is a perspective view illustrating the reducer assembly according to the first embodiment of the present disclosure from a rear perspective;

FIG. 3 is a cross-sectional view illustrating the reducer assembly according to the first embodiment of the present disclosure;

FIG. 4 is a front view illustrating the reducer assembly according to the first embodiment of the present disclosure;

FIG. 5 is a perspective view illustrating the flexible component according to the first embodiment of the present disclosure;

FIG. 6A shows the transmission path of the flexible component for the radial force according to the first embodiment of the present disclosure;

FIG. 6B shows the transmission path of the flexible component for the axial force according to the first embodiment of the present disclosure;

FIG. 7A shows the corresponding relationship between the flexible component and the outer sleeve bearing before deformation according to the first embodiment of the present disclosure;

FIG. 7B shows the corresponding relationship between the flexible component and the outer sleeve bearing after deformation according to the first embodiment of the present disclosure;

FIG. 8 is a perspective view illustrating a reducer assembly according to a second embodiment of the present disclosure from a front perspective;

FIG. 9 is a perspective view illustrating the reducer assembly according to the second embodiment of the present disclosure from a rear perspective;

FIG. 10 is a cross-sectional view illustrating the reducer assembly according to the second embodiment of the present disclosure;

FIG. 11 is a front view illustrating the reducer assembly according to the second embodiment of the present disclosure;

FIG. 12 is a perspective view illustrating the flexible component according to the second embodiment of the present disclosure;

FIG. 13 is a perspective view illustrating a reducer assembly according to a third embodiment of the present disclosure from a front perspective;

FIG. 14 is a perspective view illustrating the reducer assembly according to the third embodiment of the present disclosure from a rear perspective;

FIG. 15 is a cross-sectional view illustrating the reducer assembly according to the third embodiment of the present disclosure;

FIG. 16 is a front view illustrating the reducer assembly according to the third embodiment of the present disclosure; and

FIG. 17 is a perspective view illustrating the flexible component according to the third embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “front,” “rear,” “inner,” “outer” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the "first," "second," and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, "and / or" and the like may be used herein for including any or all combinations of one or more of the associated listed items.

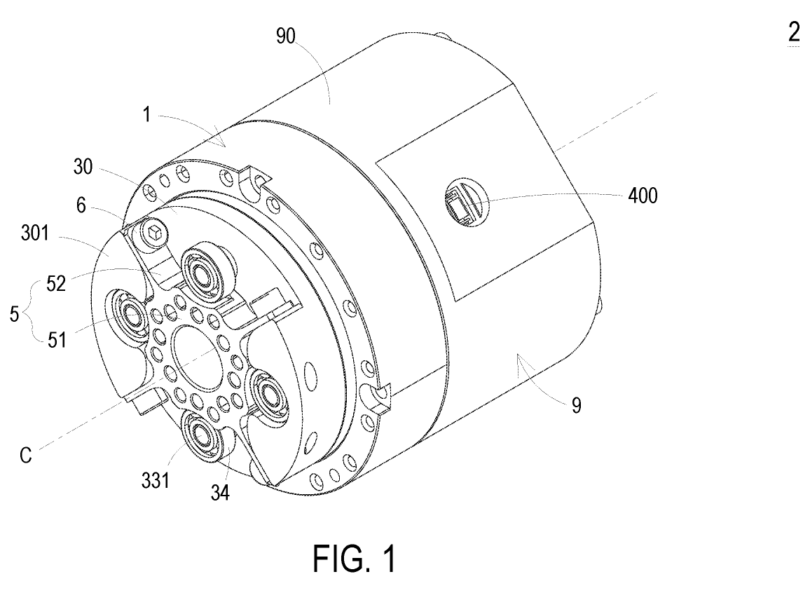

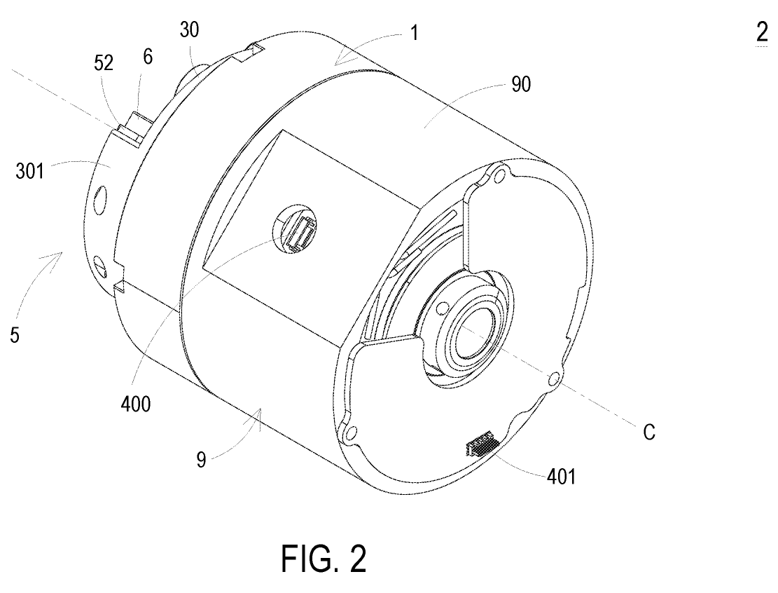

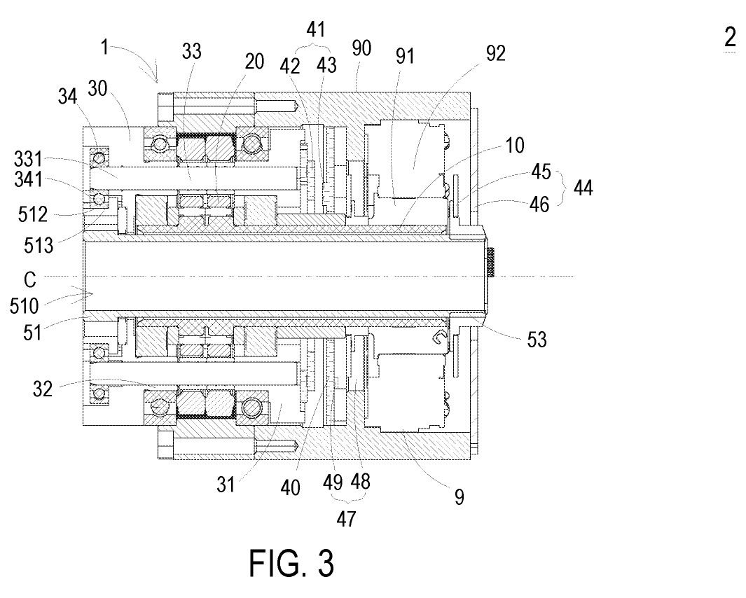

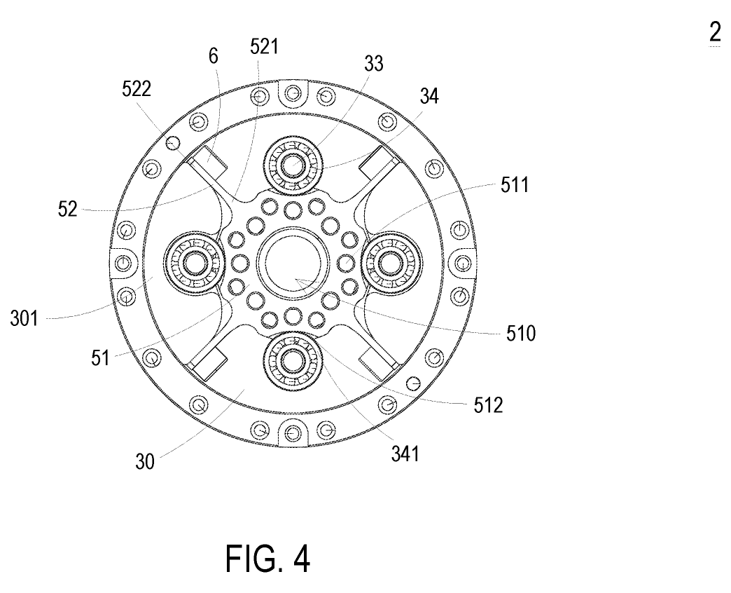

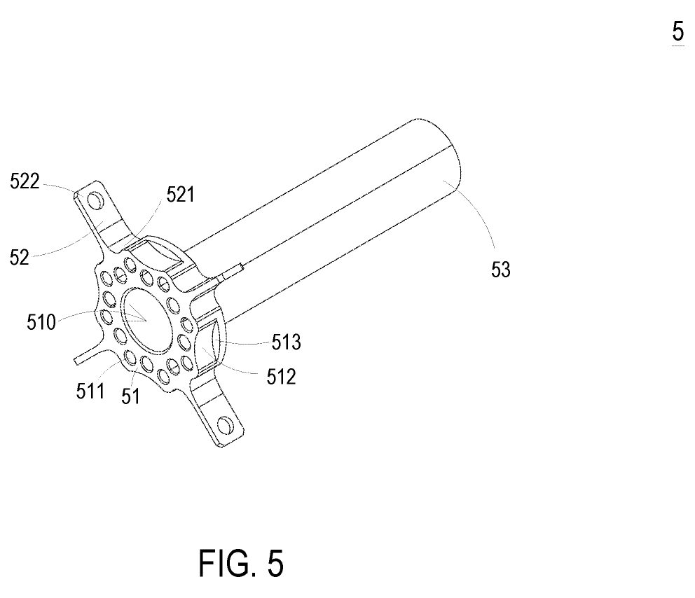

FIG. 1 and FIG. 2 are perspective views illustrating a reducer assembly according to a first embodiment of the present disclosure. FIG. 3 is a cross-sectional view illustrating the reducer assembly according to the first embodiment of the present disclosure. FIG. 4 is a front view illustrating the reducer assembly according to the first embodiment of the present disclosure. FIG. 5 is a perspective view illustrating the flexible component according to the first embodiment of the present disclosure. Please refer to FIG. 1 to FIG. 5. The present disclosure provides a reducer 1 with a torque sensing structure, which adopts a front end and rear end output design and is combined with a motor 9 to form a reducer assembly 2. In the embodiment, the reducer 1 includes an input shaft 10, a reducer main body 20, an output end 30, a first encoder module 41, a flexible component 5 and a second encoder module 44. The input shaft 10 is connected to a rotor 91 of a motor 9 along an axial direction C. The rotor 91 and the stator 92 of the motor 9 are both sleeved outside the input shaft 10, so that the power input source provided by the motor 9 can drive the input shaft 10 to rotate. The reducer main body 20 is arranged along the axial direction C, and sleeved on the input shaft 10. The output end 30 is arranged along the axial direction C and connected to the reducer main body 20. The reducer main body 20 includes an opening (not shown) located at the substantial center position thereof for a part of the input shaft 10 to pass through. In the embodiment, the input shaft 10 is a hollow input shaft, which is located substantially at the center of the reducer assembly 2 and is driven by the motor 9 to drive the reducer main body 20 and the output end 30 to rotate. In the embodiment, the output end 30 includes a first output plate 31 and a second output plate 32, which are arranged at two opposite outer sides of the reducer main body 20 along the axial direction C, and connected to the reducer main body 20 through a plurality of straight shafts 33. The first output plate 31 faces the motor 9. A power input source of the motor 9 is inputted through the input shaft 10, and an eccentric movement of the reducer main body 20 and the plurality of straight shafts 33 is driven by the input shaft 10, so that the plurality of straight shafts 33 drive the first output plate 31 and the second output plate 32 to rotate, and a power output is provided by the first output plate 31 and the second output plate 32, respectively. The first encoder module 41 is disposed between the first output plate 31 of the output end 30 and the motor 9, and configured to measure a rotational position of the output end 30. The flexible component 5 includes a flexible body 51 and at least two flexible arms 52. The flexible body 51 is arranged on the output end 30 along the axial direction C. The at least two flexible arms 52 are perpendicular to the axial direction C, and extended outwardly from the flexible body 51. The at least two flexible arms 52 are allowed to deform under force and make the flexible body 51 to form a shifted position difference. The second encoder module 44 is spatially corresponding to the flexible component 5. Preferably but not exclusively, the shifted position difference measured by the second encoder module 44 allows an output torque value to be calculated by comparing the rotational position of the output end measured by the first encoder module 41. That is to say, in the present disclosure, the first encoder module 41 is used to measure a rotational position of the output end 30 of the reducer 1, and the second encoder module 44 is used to measure the position of the flexible component 5. There is a shifted position difference between the two measured positions, and the shifted position difference is result of the deformation of the flexible component 5 after being subject to a torsional force. If the stiffness of the flexible component 5 is obtained, the output torque value can be calculated, so that the application of the torque sensor is realized. Thereby, the reducer 1 realizes torque sensing and can perform closed-loop feedback control to improve the control accuracy of the system.

Notably, in the embodiment, the first output plate 31 and the second output plate 32 are respectively located at two opposite outer sides of the reducer main body 20, so that the reducer main body 20 is located between the first output plate 31 and the second output plate 32, and both of the first output plate 31 and the second output plate 32 can be used for power output. The first output plate 31 faces the motor 9. The flexible component 5 is disposed on the second output plate 32 and axially penetrates the first output plate 31 and the motor 9 along the axial direction C, so that the flexible component 5 is connected to the second encoder module 44. In the embodiment, the first encoder module 41 is disposed between the first output plate 31 and the motor 9, and configured to measure the rotational position of the first output plate 31 for feedback control, thereby improving the accuracy of the cycloid reducer 1. Preferably but not exclusively, in the embodiment, the first encoder module 41 includes an encoder 42 and an encoder read head 43. The encoder 42 is connected to the first output plate 31 through a connection board, and the first output plate 31 drives the encoder 42 to output and rotate synchronously. In the embodiment, the encoder read head 43 is spatially corresponding to the encoder 42, and configured to measure the rotational position of the first output plate 31 for feedback control. In the embodiment, the input shaft 10 is a hollow input shaft. The flexible component 5 further includes an extension end 53. Preferably but not exclusively, the extension end 53 passes through the input shaft 10 along the axial direction C from the flexible body 51 to a rear end of the motor 9. Preferably but not exclusively, in the embodiment, the second encoder module 44 includes an encoder 45 and an encoder read head 46. The encoder 45 is connected to the extension end 53 of the flexible component 5 through a connection element. The extension end 53 of the flexible component 5 can drive the encoder 45 to output and rotate synchronously. In the embodiment, the encoder read head 46 is spatially corresponding to the encoder 42 and configured to measure the shifted position difference of the flexible component 5 to realize torque sensing. In the embodiment, the reducer 1 further includes a third encoder module 47 disposed between the first output plate 31 and the motor 9. Preferably but not exclusively, the third encoder module 47 includes a motor encoder 48 and an encoder read head 49 configured to measure a rotational position of a driving shaft or the input shaft 10 for feedback control. Preferably but not exclusively, in the embodiment, the encoder read head 43 of the first encoder module 41 and the encoder read head 49 of the third encoder module 47 are arranged on two opposite sides of a circuit board 40, respectively. It is helpful to reduce the costs and improve the convenience and the space utilization. Since the first output plate 31 and the second output plate 32 are both over-reduction ratio (i.e., the output ends 30), the first output plate 31 is located relatively at the rear end, adjacent to the fixed housing 90 and the servo motor 9. Preferably but not exclusively, the output wires of the first encoder module 41 and the third encoder module 47 are led out from the encoder output terminal 400 through the fixed housing 90 but not affected by the input shaft 10. Preferably but not exclusively, the encoder output terminal 401 of the second encoder module 44 is led out from the rear end of the motor 9. Certainly, the present disclosure is not limited thereto.

In the embodiment, the reducer 1 with the torque sensing structure further includes a control module (not shown) connected to the first encoder module 41 and the second encoder module 44. The control module compares the output of the first encoder module 41 with the output of the second encoder module 44 corresponding to the flexible component 5 to calculate the output torque value. Preferably but not exclusively, in another embodiment, a control module (not shown) of the reducer 1 with the torque sensing structure is disposed outside the reducer 1 and the motor 9, and connected to the second encoder module 44 and the third encoder module 47 to compare the output of the third encoder module 47 at the input shaft 10 and the output of the second encoder module 44 corresponding to the flexible component 5 to perform torque sensing. Certainly, the location of the control module is adjustable according to the practical requirements. The present disclosure is limited thereto and not redundantly described hereafter.

On the other hand, in the embodiment, the flexible component 5 includes four flexible arms 52 extended radially from inside to outside. Each flexible arm 52 is a thin-walled structure and perpendicular to the second output plate 32 of the output end 30, so as to provide sufficient deformation to cause the flexible body 51 to form a shifted position difference when the reducer 1 outputs the torque. Thus, the application of the torque sensor is achieved. Preferably but not exclusively, in the embodiment, the inner ends 521 of the at least two flexible arms 52 are connected to the flexible body 51, and the outer ends 522 of the at least two flexible arms 52 are fixed to the lateral wall of the protrusion 301 of the output end 30 along the circumferential direction by at least one screw 6, so as to provide better torque resistance.

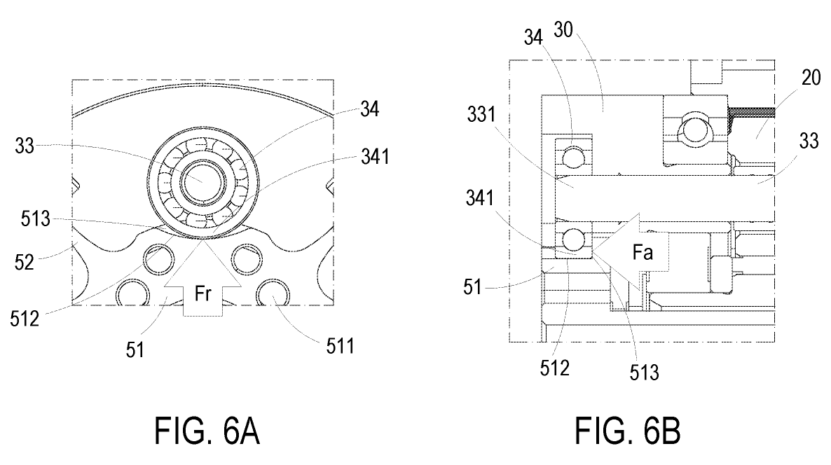

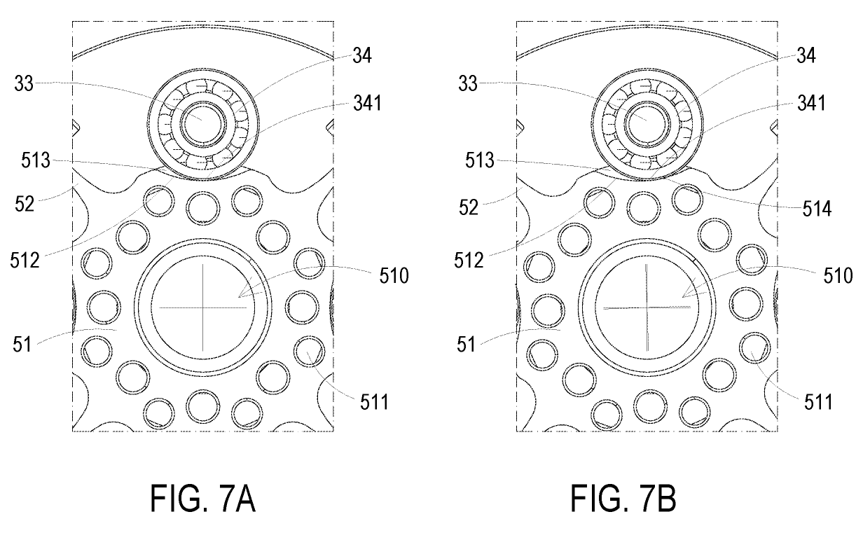

Notably, the flexible component 5 of the present disclosure should absorb the torque as much as possible while the radial force and the axial force are supported through other structures, such as cross rollers or bearing sets. FIG. 6A and FIG. 6B respectively show the transmission paths of the flexible component for the radial force and the axial force according to the first embodiment of the present disclosure. FIG. 7A and FIG. 7B respectively show the corresponding relationship between the flexible component and the outer sleeve bearing before and after deformation according to the first embodiment of the present disclosure. Please refer to FIG. 1 to FIG. 5, FIG. 6A, FIG. 6B, FIG. 7A and FIG. 7B. In the embodiment, the first output plate 31 and the second output plate 32 transmit the torque through the eccentric motion of the plurality of straight shafts 33. Notably, in the embodiment, each of the plurality of straight shafts 33 includes an extension section 331 penetrating through the second output plate 32, and connected to the second output plate 32 in an interference manner. In addition, each extension section 331 of the straight shaft 33 interferes with an outer sleeve bearing 34. In the embodiment, the flexible body 51 further includes a plurality of grooves 512 spatially corresponding to the outer sleeve bearings 34 outside the plurality of straight shafts 33. Each outer ring 341 of the outer sleeve bearing 34 is partially in contact with the corresponding groove 512 and located at the bottom 513 of the corresponding groove 512. In the embodiment, the reducer 1 is further equipped with a clamp or other operating components through the hollow hole 510 or the mounting hole 511 on the flexible component 5. When the reducer 1 is running, the outer ring 341 of the outer sleeve bearing 34 further provides a radial supporting force Fr for the flexible body 51. Moreover, while the flat surface of the outer ring 341 of the outer sleeve bearing 34 is attached to the flat surface of the bottom 513 of the corresponding groove 512, an axial supporting force Fa is further provided for the flexible body 51. In that, unnecessary deformation of the flexible component 5 is effectively avoided and the measurement accuracy is not affected. Furthermore, in the embodiment, each of the plurality of grooves 512 has an arc curvature corresponding to the outer sleeve bearing 34. Preferably but not exclusively, the arc curvature is greater than an outer diameter of the outer sleeve bearing 34. In that, when the flexible component 5 is deformed, there is still room for the flexible component 5 to deform and rotate. In addition, the arc curvature of the groove 512 can be designed according to the limit angle of the flexible body 51 after deformation, so as to optimize the contact position as the limit position stop point. Thereby, an interference point 514 of the flexible body 51 and the outer sleeve bearing 34 is designed at one end of the groove 512 and served as the limit position stop point for allowable deformation. Certainly, the structure of the groove 512 is adjustable and not limited to one single arc curvature. The grooves 512 with multi-segment design capable of forming the interference points with the outer sleeve bearing 34 at the maximum deformation angle are suitable for the present disclosure. Therefore, the flexible body 51 of the present disclosure can be disposed on the output plate of the rotating mechanical device along the axial direction C to achieve torque sensing.

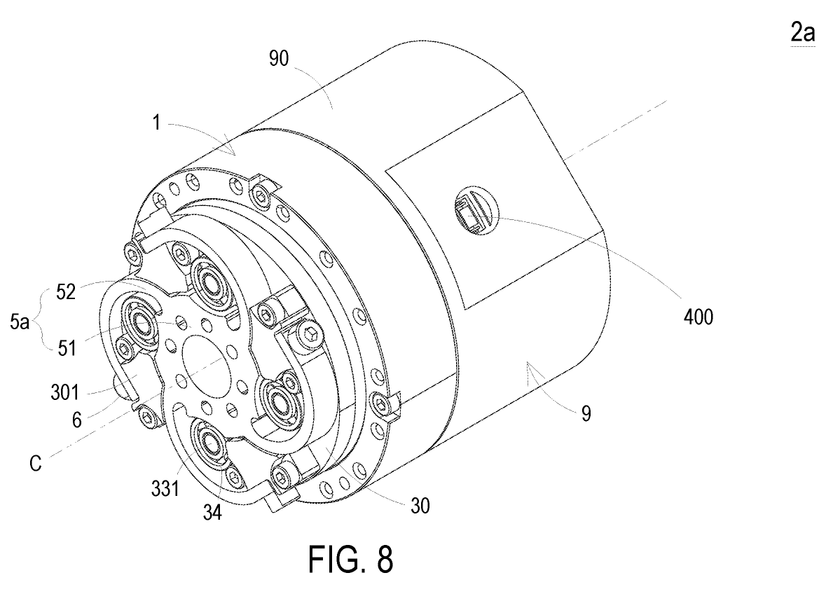

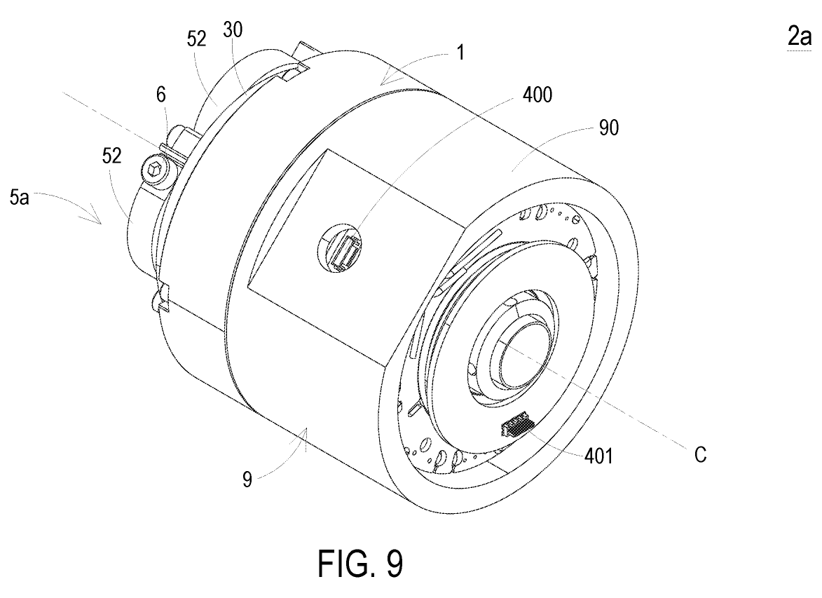

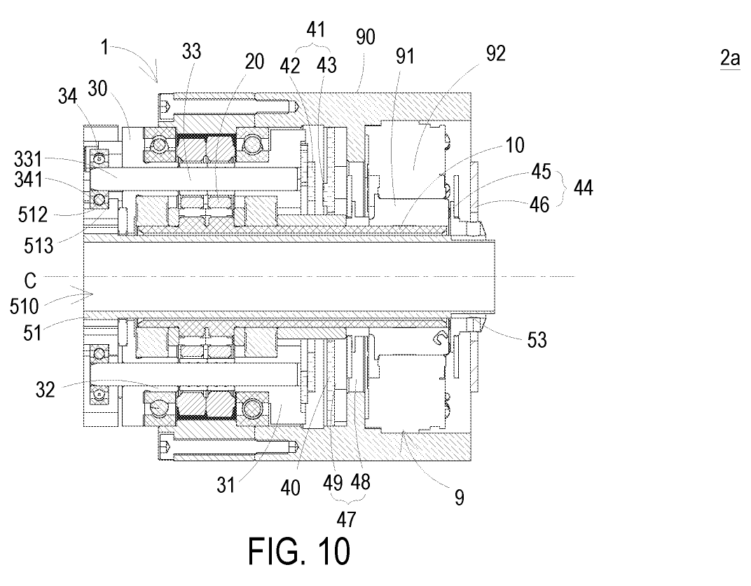

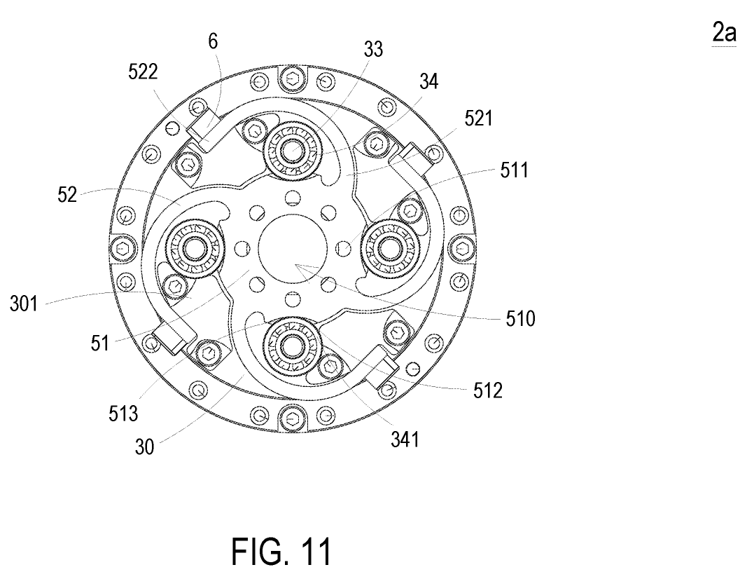

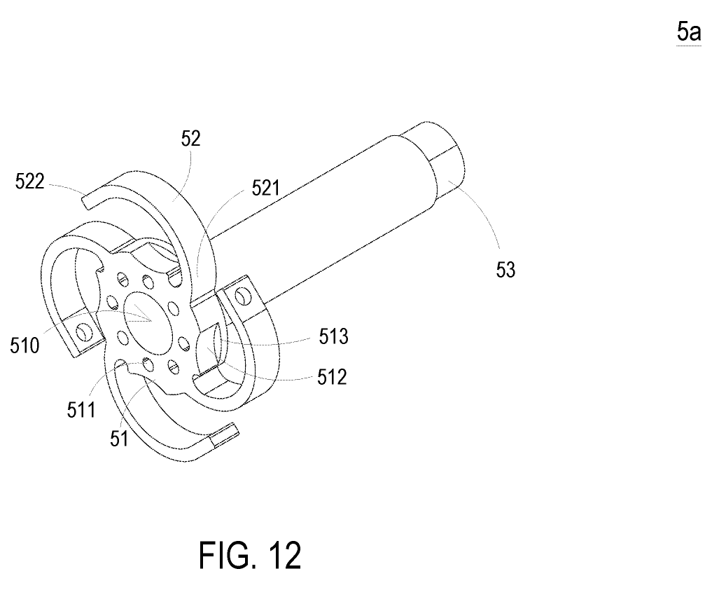

FIG. 8 and FIG. 9 are perspective views illustrating a reducer assembly according to a second embodiment of the present disclosure. FIG. 10 is a cross-sectional view illustrating the reducer assembly according to the second embodiment of the present disclosure. FIG. 11 is a front view illustrating the reducer assembly according to the second embodiment of the present disclosure. FIG. 12 is a perspective view illustrating the flexible component according to the second embodiment of the present disclosure. In the embodiment, the structures, elements and functions of the reducer assembly 2a and the flexible component 5a are similar to those of the reducer assembly 2 and the flexible component 5 of FIG. 1 to FIG. 5, and are not redundantly described herein.

In the embodiment, the flexible component 5a includes four flexible arms 52 extended and bent from inside to outside. Each flexible arm 52 is a thin-walled structure and perpendicular to the second output plate 32 of the output end 30, so as to provide sufficient deformation to cause the flexible body 51 to form a shifted position difference when the reducer 1 of the reducer assembly 2a outputs the torque. Thus, the application of the torque sensor is achieved. Preferably but not exclusively, in the embodiment, each inner end 521 of the flexible arm 52 is connected to the flexible body 51, and each outer end 522 of the flexible arm 52 is fixed to the lateral wall of the protrusion 301 of the output end 30 along the radial direction by at least one screw 6, so as to provide better torque resistance.

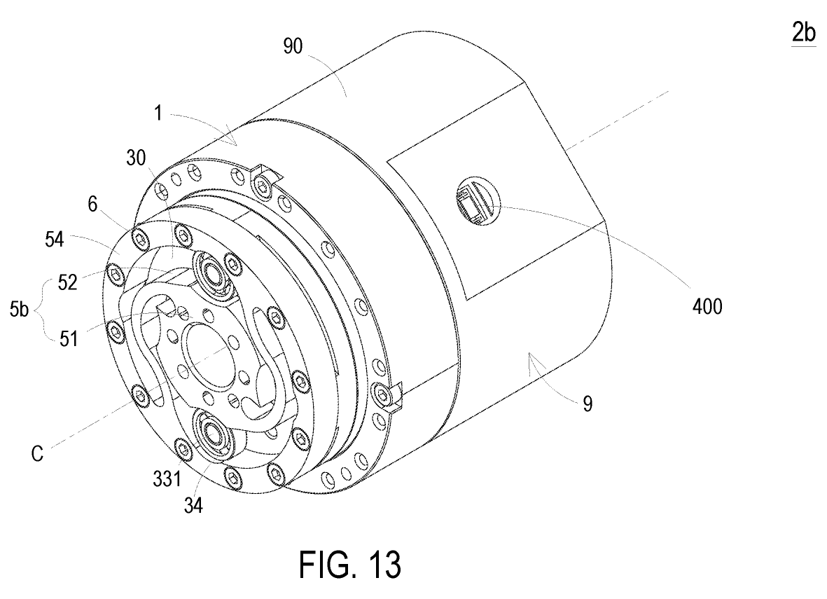

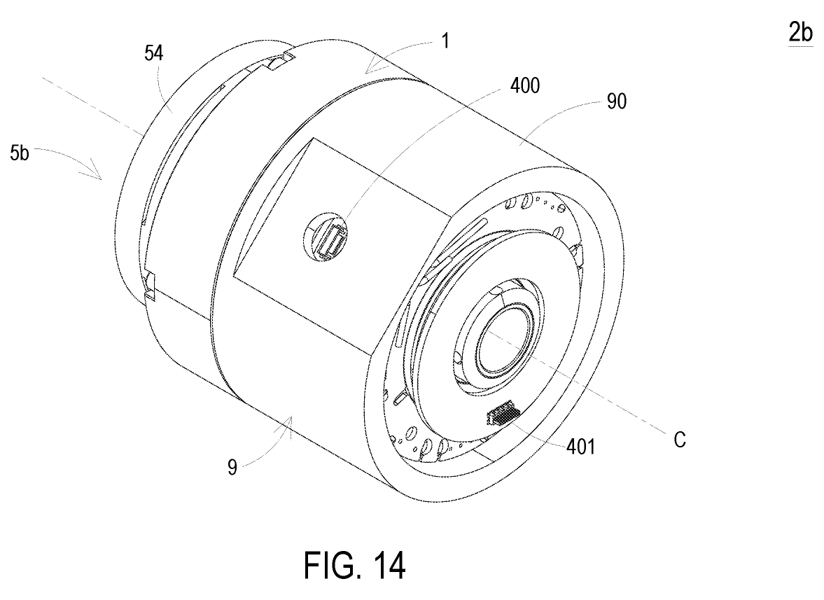

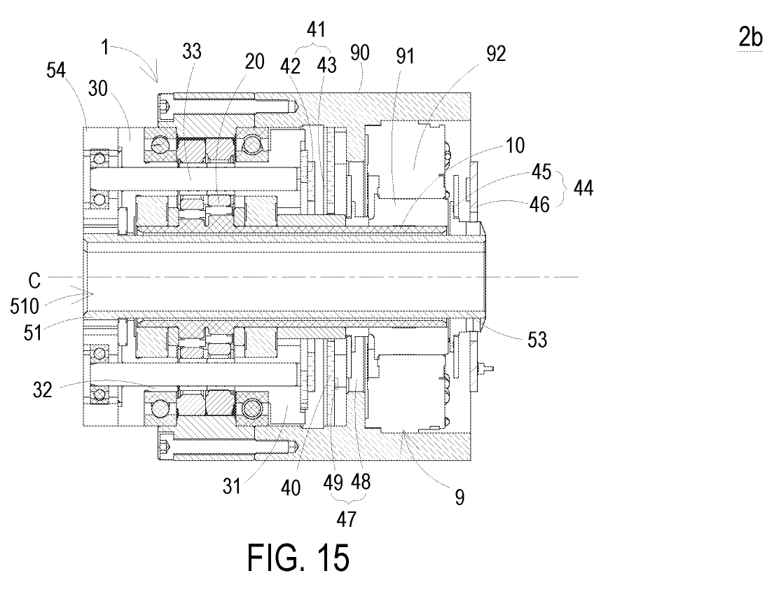

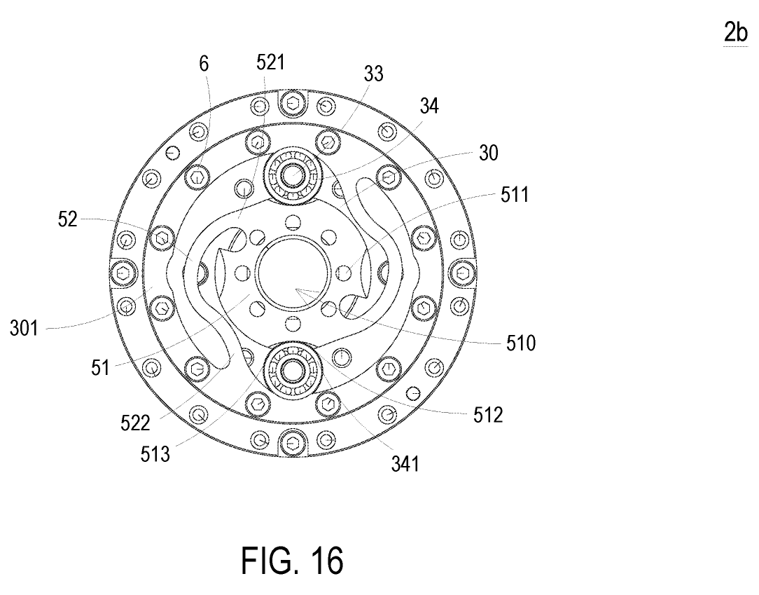

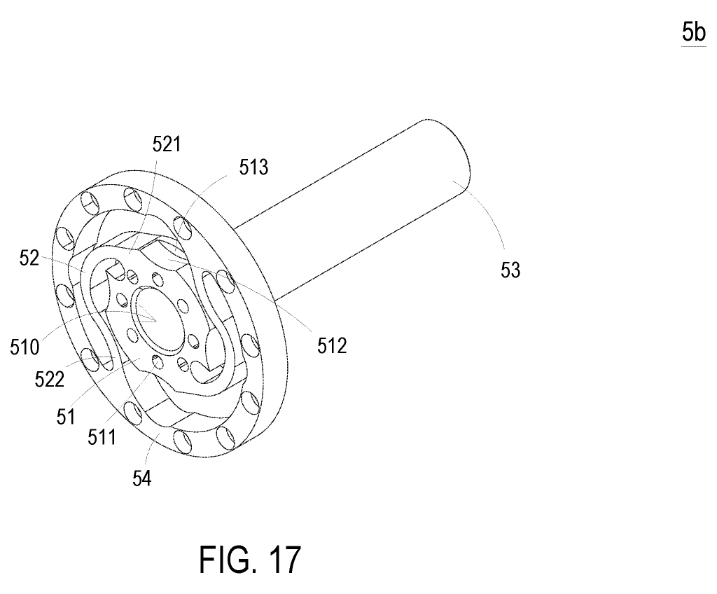

FIG. 13 and FIG. 14 are perspective views illustrating a reducer assembly according to a third embodiment of the present disclosure. FIG. 15 is a cross-sectional view illustrating the reducer assembly according to the third embodiment of the present disclosure. FIG. 16 is a front view illustrating the reducer assembly according to the third embodiment of the present disclosure. FIG. 17 is a perspective view illustrating the flexible component according to the third embodiment of the present disclosure. In the embodiment, the structures, elements and functions of the reducer assembly 2b and the flexible component 5b are similar to those of the reducer assembly 2 and the flexible component 5 of FIG. 1 to FIG. 5, and are not redundantly described herein. In the embodiment, the flexible component 5b further includes a fixing ring 54 disposed on an outer periphery of the flexible body 51. Two flexible arms are extended and bent from inside to outside. In addition, the inner ends 521 of the two flexible arms 52 are respectively connected to the flexible body 51, the outer ends 522 of the two flexible arms 52 are respectively connected to the fixing ring 52, and the fixing ring 54 is fixed to the output end 30 along the axial direction C by a plurality of screws 6, so as to provide better torque resistance.

From the above, for the flexible components 5, 5a, 5b disposed on the output end 30 of the reducer 1, at least two flexible arms 52 are included in the structure. The outward extending and bending types of the flexible arms 52 from the flexible body 51 and the number of the flexible arms 52 are adjustable according to the practical requirements. With the thin-walled structure of the flexible arms 52 perpendicular to the output end 30, it allows to provide sufficient deformation, so that the accuracy of torque sensing is improved. On the other hand, the fixing of the flexible components 5, 5a, 5b to the output end 30 of the reducer 1 is mainly achieved through the outer end 522 of the flexible arm 52. Fixing the outer end 522 of the flexible arm 52 by means of the screw 6 in combination with the protrusion 301 or the fixing ring 54 can enable the flexible components 5, 5a, 5b to maintain sufficient torque resistance. Certainly, the present disclosure is not limited thereto, and not redundantly described hereafter.

In summary, the present disclosure provides a reducer with a torque sensing structure and a flexible component thereof. Torque sensing is achieved through the configuration of the flexible components and encoders for closed-loop feedback control, so as to improve the control accuracy of the system. The reducer of the present disclosure is miniaturized by optimizing the component structure, it facilitates to arrange encoders between the reducer and the motor for closed-loop feedback control, and the output end of the reducer is further combined with a flexible component to achieve torque sensing. The first encoder module is used to measure a rotational position of the output end of the reducer, and the second encoder module is used to measure the position of the flexible component. There is a shifted position difference between the two measured positions, and the shifted position difference is the result of the deformation of the flexible component after being subjected to a torsional force. If the stiffness of the flexible component is obtained, the output torque value is calculated, so that the application of the torque sensor is realized. Furthermore, the reducer of the present disclosure includes a front output plate and a rear output plate served as the output ends. The rear output plate faces the motor. The flexible component is disposed on the front output plate, and axially penetrates to the rear output plate to connect with the second encoder module. The first encoder module can be constructed integrally with a third encoder module between the rear output plate and the motor, and share one encoder reader to reduce the costs and improve the convenience and the space utilization. On the other hand, the flexible component arranged at the output end includes a flexible body and at least two flexible arms. The at least two flexible arms are perpendicular to the axial direction of the output end, and bent or extended outward from the flexible body. In that, when the reducer outputs the torque, the flexible body is deformed by the torque to form a shifted position difference, so as to further realize the application of the torque sensor. Since the inner end of the flexible arm is extended outward or bent from the flexible body and has a thin-walled structure perpendicular to the output plate, it allows to provide sufficient deformation. The outer end of the flexible arm is fastened to a lateral wall of the protrusion at the output end along the circumferential direction or radial direction (vertical to the axial direction) by at least one screw, or fixed through a fixing ring to provide better torque resistance. Certainly, the flexible components should absorb the torque as much as possible, while the radial force and the axial force are supported through other structures, such as cross rollers or bearing sets. In the reducer of the present disclosure, the front output plate and rear output plate transmit the torque through the eccentric motion of multiple straight shafts. The straight shaft includes an extended section running through the front output plate and combined with an outer sleeve bearing and the front output plate in an interference manner. Notably, the flexible component of the present disclosure further includes a plurality of grooves disposed on an outer periphery of the flexible body, and corresponding to the outer sleeve bearings structured on the plurality of straight shafts. The outer rings of the outer sleeve bearings are located in the corresponding grooves. In this way, the outer ring of the outer sleeve bearing is allowed to provide a radial supporting force for the flexible body. Moreover, while the flat surface of the outer ring of the outer sleeve bearing is attached to the flat surface of the corresponding groove, it is allowed to provide an axial supporting force for the flexible body. In addition, the groove is designed to have a larger arc curvature corresponding to the outer diameter of the outer ring bearing, so as to form an interference point between the flexible body and the outer sleeve bearing at one end of the groove. The interference point is served as a limit position stop point for allowable deformation. In other words, the arc curvature of the groove can be designed according to the limit angle of the flexible body after deformation to optimize the contact position as the limit position stop point. Certainly, in the present disclosure, the structure of the groove is not limited to one single arc curvature. The grooves with multi-segment design can form the interference points with the outer sleeve bearing at the maximum deformation angle. Therefore, the flexible body of the present disclosure can be axially disposed on the output plate of the rotating mechanical device to achieve torque sensing.

While the disclosure has been described in terms of what is presently considered to be the most practical and preferred embodiments, it is intended to cover various modifications and similar arrangements included within the spirit and scope of the appended claims which are to be accorded with the broadest interpretation so as to encompass all such modifications and similar structures.

What is claimed is:

1. A reducer with a torque sensing structure, comprising:
an input shaft, connected to a motor along an axial direction, and driven by the motor;
a reducer main body, arranged along the axial direction, and sleeved on the input shaft;
an output end, arranged along the axial direction and connected to the reducer main body, wherein the input shaft is driven by the motor to rotate the reducer main body to act on the output end, and the output end is rotated;
a first encoder module, disposed between the output end and the motor and configured to measure a rotational position of the output end;
a flexible component comprising a flexible body and at least two flexible arms, wherein the flexible body is axially arranged on the output end, the at least two flexible arms are perpendicular to the axial direction, and extended outwardly from the flexible body, and the at least two flexible arms are allowed to deform under force and make the flexible body to form a shifted position difference; and
a second encoder module, spatially corresponding to the flexible component, wherein the shifted position difference measured by the second encoder module allows an output torque value to be calculated by comparing the rotational position of the output end measured by the first encoder module.

2. The reducer with the torque sensing structure according to claim 1, wherein the output end comprises a first output plate and a second output plate, which are arranged at two opposite outer sides of the reducer main body along the axial direction, and connected to the reducer main body through a plurality of straight shafts, wherein the first output plate faces the motor, a power input source of the motor is inputted through the input shaft, and an eccentric movement of the reducer main body and the plurality of straight shafts is driven by the input shaft, so that the plurality of straight shafts drive the first output plate and the second output plate to rotate, and a power output is provided by the first output plate and the second output plate, respectively.

3. The reducer with the torque sensing structure according to claim 2, wherein the first encoder module is disposed between the first output plate and the motor, and configured to measure the rotational position of the first output plate for feedback control.

4. The reducer with the torque sensing structure according to claim 3, wherein the first encoder module comprises an encoder and an encoder read head, the encoder is connected to the first output plate, and the first output plate drives the encoder to output and rotate synchronously, wherein the encoder read head is spatially corresponding to the encoder, and configured to measure the rotational position of the first output plate for feedback control.

5. The reducer with the torque sensing structure according to claim 4, further comprising a third encoder module disposed between the first output plate and the motor, wherein the input shaft is a hollow input shaft, and the third encoder module comprises a motor encoder and an encoder read head configured to measure a rotational position of the input shaft or a driving-shaft position for feedback control, wherein the encoder read head of the first encoder module and the encoder read head of the third encoder module are arranged on two opposite sides of a circuit board, respectively.

6. The reducer with the torque sensing structure according to claim 2, wherein the input shaft is a hollow input shaft, the flexible component further comprises an extension end, the extension end passes through the input shaft along the axial direction from the flexible body to a rear end of the motor, wherein the second encoder module is arranged at the rear end, and configured to measure rotation of the extension end to realize torque sensing.

7. The reducer with the torque sensing structure according to claim 2, wherein each of the plurality of straight shafts comprises an extension section penetrating through the second output plate and connected to the second output plate in an interference manner, and the extension section interferes with an outer sleeve bearing.

8. The reducer with the torque sensing structure according to claim 7, wherein the flexible body further comprises a plurality of grooves spatially corresponding to the outer sleeve bearings outside the plurality of straight axes, and the outer sleeve bearing is in contact with a corresponding one of the plurality of grooves.

9. The reducer with the torque sensing structure according to claim 8, wherein the plurality of grooves have an arc curvature corresponding to the outer sleeve bearing, and the arc curvature is greater than an outer diameter of the outer sleeve bearing, so as to form an interference point between the flexible body and the outer sleeve bearing at one end of the corresponding one of the grooves.

10. The reducer with the torque sensing structure according to claim 1, wherein the at least two flexible arms are extended radially from inside to outside, inner end of the at least two flexible arms are connected to the flexible body, and outer ends of the at least two flexible arms are respectively fixed to a lateral wall of a protrusion of the output end along a circumferential direction by at least one screw.

11. The reducer with the torque sensing structure according to claim 1, wherein the at least two flexible arms are extended and bent from inside to outside, inner end of the at least two flexible arms are connected to the flexible body, and outer ends of the at least two flexible arms are respectively fixed to a lateral wall of a protrusion of the output end along a radial direction by at least one screw.

12. The reducer with the torque sensing structure according to claim 1, wherein the flexible component further comprises a fixing ring disposed on an outer periphery of the flexible body, the at least two flexible arms are extended and bent from inside to outside, inner end of the at least two flexible arms are connected to the flexible body, outer ends of the at least two flexible arms are respectively connected to the fixing ring, and the fixing ring is fixed to the output end along the axial direction by a plurality of screws.

13. A flexible component, configured to be disposed on an output end of a rotating mechanical device along an axial direction, wherein the flexible component comprises:
a flexible body, wherein the flexible body is disposed on the output end along the axial direction; and
at least two flexible arms, wherein the at least two flexible arms are perpendicular to the axial direction, and extended outwardly from the flexible body, wherein when the rotating mechanical device outputs torque through the output end, the at least two flexible arms are allowed to deform under force and make the flexible body to form a shifted position difference, and the shifted position difference allows an output torque value to be calculated by comparing a rotational position of the output end.
